(19) United States
(12) Patent Application Publication
(10) Pub. No.: US 2026/0295684 A1
(43) Pub. Date: Oct. 1, 2026

(54) FASTENING AND COUPLING APPARATUS FOR A ROTATING TOOL, AND POWER TOOL HAVING A FASTENING AND COUPLING APPARATUS OF THIS TYPE

(71) Applicant: C. & E. Fein GmbH, Schwaebisch Gmuend/ Bargau (DE)

(72) Inventor: Fabian BEK, Boebingen (DE)

(73) Assignee: C. & E. Fein GmbH, Schwaebisch Gmuend/ Bargau (DE)

(21) Appl. No.: 19/629,841

(22) Filed: Mar. 26, 2026

(30) Foreign Application Priority Data
Mar. 26, 2025 (EP) 25166429.8

(51) Int. Cl. B23B 31/20; B23B 31/00

(52) U.S. Cl. CPC B23B 31/20; B23B 31/008; B23B 2231/2089

(57) ABSTRACT

A fastening and coupling apparatus for a rotating tool, which is provided for connection to a drive unit of a power tool. A collet receives a tool shank and a clamping device maintains a clamping position of the collet in a state unloaded from the outside. A releasing device applies a releasing force to the clamping device while the coupling shaft is at a standstill and to move the collet into a releasing position thereby. An actuating device actuates the releasing device by a user of the power tool, in particular, by manual power. In this way, a simple possibility is provided for fastening and for releasing a tool to or from the power tool without a separate tool.

This nonprovisional application claims priority under 35 U.S.C. § 119(a) to European Patent Application No. 25166429.8, which was filed on Mar. 26, 2025, and which is herein incorporated by reference.

### BACKGROUND OF THE INVENTION

### Field of the Invention

The present invention relates to a fastening and coupling apparatus for a rotating tool, which is provided for connection to a drive unit of a power tool having a rotating drive, as well as to a power tool having a fastening and coupling apparatus of this type and a drive unit. The driving torque generated by the drive unit is transferred to the fastening and coupling apparatus, which is connected to the drive unit and in which the rotating tool is fastened, and places the tool into rotation in this manner. The rotating tool is thus coupled to the drive unit by the fastening and coupling apparatus. The rotating drive of the drive unit is generally an electric motor, although other drives, such as an internal combustion engine, are also conceivable.

### Description of the Background Art

Receiving and fastening a tool shank with the aid of a collet has long been known in the prior art. A collet can be understood to be an essentially cylindrical sleeve for coaxially receiving the tool shank by an outer end, whose lateral surface is pressed radially to the inside against the tool shank and is clamped in place in this manner. For this purpose, the lateral surface of the collet is preferably provided with one or multiple slits, which run in parallel to the longitudinal axis of the collet and start at the outer end of the collet. One or multiple tongues, preferably of the same width, are formed hereby on the lateral surface, which transition into the continuous, non-slitted lateral surface on their inner ends opposite the outer end of the collet. Due to their elasticity, these tongue may be pressed radially to the inside and clamp the tool shank inserted into the collet. The outer diameter of the tool shank is preferably equal to the inner diameter of the collet, so that the tool shank may be inserted into the collet without clearance, and the tongues of the collet need to be only slightly pressed radially to the inside against the tool shank to clamp the latter in place. In this way, a smooth running of the rotating tool is ensured during the use of the power tool.

When an “outer” end of individual components is mentioned here and in the following, this always means the direction along the longitudinal axis of the power tool toward the end of the collet, at which the latter receives the tool shank. An “inner” end of a component correspondingly means the end along the longitudinal axis of the power tool opposite the outer end. The same applies to terms such as “to the outside” or “to the inside.” The outer end of the collet thus also forms the outer end of the entire power tool.

The collet is preferably detachably or non-detachably connected on its inner end to an output shaft of the drive unit of the power tool, in particular as a single piece, in any case, however, rotatably fixedly connected thereto, so that the torque of the drive unit may be transferred via its output shaft to the collet and the tool shank clamped therein and thus to the rotating tool. Due to the rotatably fixed connection between the collet and the output shaft of the drive unit, it is ensured that, during operation, the collet remains fixedly connected to the output shaft during the rotation of the drive unit, and both the collet and the output shaft rotate together as a unit.

The pressing of the tongues of the collet radially to the inside, and thus the clamping of the tool shank, preferably takes place in that the collet has, in the region of the tongues, a conical outer face, at least in sections, which tapers toward the inner end of the collet. The collet is inserted at its inner end into a collet receptacle, which may also essentially have the shape of a cylindrical sleeve and is arranged coaxially to the collet, the collet being able to protrude axially over the end of the collet receptacle at the outer end of the collet receptacle. The collet receptacle also has a conical face on its inner surface, which tapers in the same direction and has the same inclination as the conical face of the collet.

If the collet is now moved axially to the inside relative to the collet receptacle, the tongues of the collet are pressed radially to the inside, due to the wedge action of the two conical faces arranged relative to each other, thereby reducing the width of the slits running between the tongues. As described above, a tool shank inserted into the collet is clamped thereby.

A collet known from the prior art is provided with a male thread at its inner end and is screwed into a corresponding female thread in the outer open end of the collet receptacle. The collet is furthermore provided with an outer hexagon on its axial section extending over the collet receptacle, and the collet receptacle also has an outer hexagon, or at least two parallel faces, on its outer face for setting an open-end wrench. The axial movement of the collet relative to the collet receptacle in the direction of its inner end then takes place in that, with the tool shank inserted, the user screws the collet into the collet receptacle, using an open-end wrench, and holds it in place with the aid of a further open-end wrench to prevent the co-rotation thereof. If the collet or the collet receptacle may be otherwise blocked and thus prevented from rotating, one of the two open-end wrenches is unnecessary.

This known type of fastening of the tool shank in the collet is, however, not satisfactory from the standpoint of the operating comfort of the power tool, since it is relatively time-consuming, and a separate tool, namely an open-end wrench, is furthermore needed for this purpose. However, experience from practice shows that separate tools of this type are often misplaced or at least are not in the place where the user needs them at the moment.

### SUMMARY OF THE INVENTION

It is therefore an object of the present invention to provide a simple possibility for fastening and for releasing a tool on or from the power tool without a separate tool.

The invention is described in connection with a grinding machine and, in particular, with a straight grinder. It is noted, however, that the invention may also be used independently of the type of power tool and the rotating tool connected thereto. The invention may thus also be used, for example, for a buffing machine, a circular saw, a drilling machine, or a milling machine.

For example, the power tool can be hand-held by the user. The power tool can be furthermore preferably designed for a battery operation, a mains operation, or either a battery operation or a mains operation.

The rotation axis of the rotating drive of the power tool preferably coincides with the rotation axis of the rotating tool, as is the case, for example, in the example of the straight grinder in this case.

The invention is based on the fact that the rotating tool, in the case of the example of the straight grinder, i.e., the grinding tool, in this case, has a rod-shaped tool shank for connection to the fastening and coupling apparatus of the power tool. The tool shank is, in particular, cylindrical, although it may also have a hexagonal, square, or another, in particular rotationally symmetrical, shape in cross-section. Cylindrical tool shanks are available as standard in different diameters, for example, 3 mm, 6 mm, 8, mm, or 1/4 inch.

The fastening and coupling apparatus according to the invention for a rotating tool, which is provided for connection to a drive unit of a power tool having a rotating drive, can have the components and subunits described below. It is noted that these components and subunits do not have to be distinct from one another, i.e., not without overlap. Instead, components or subunits which are different from each other may have individual elements in common. In particular, individual subunits may completely contain individual components.

The fastening and coupling apparatus has a coupling shaft with a longitudinal axis, the coupling shaft being rotatable around the longitudinal axis with the aid of the rotating drive when the fastening and coupling apparatus is connected to the drive unit of the power tool. The coupling shaft is connected in a torque-transmitting manner to an output shaft of the drive unit, in particular to a motor shaft of an electric motor, the connection preferably being coaxial, as is the case, for example, in a straight grinder. The connection between the output shaft and the coupling shaft may also take place via a gearset, for example a spur or planetary gearset, the arrangement between the output shaft and the coupling shaft then being able to take place in an offset manner. However, the connection may also take place in such a way that the two shafts enclose an angle other than zero, in particular a right angle, as is the case, for example, in an angle grinder. The connection then preferably takes place via a joint or an angular gearset, in particular a bevel gear mechanism.

When a “rotating coupling shaft” is mentioned in the following, this can mean that the coupling shaft rotates at a rotational speed which is suitable for using the power tool with the rotating tool, i.e., at which a processing of a workpiece by the rotating tool is possible. This rotational speed does not necessarily have to be constant; for example, different rotational speed steps or ranges may also be provided in the drive unit for using the power tool. Low rotational speeds which are run through, for example, when starting up the coupling shaft from a standstill, should, however, not come under the term “rotating coupling shaft.”

The fastening and coupling apparatus furthermore can have a collet for detachably receiving an, in particular, cylindrical tool shank. Due to a relative movement along the longitudinal axis in relation to a collet receptacle rotatably fixedly connected to the coupling shaft, in particular as a single piece, the collet is movable between a clamping position, in which the tool shank is clamped in the collet in such a way that it is rotatably fixedly connected to the coupling shaft and is rotatably around the longitudinal axis, and a releasing position, in which the tool shank may be removed from the collet or inserted into the collet. The functionality of the collet is insofar essentially identical to the prior-art collet described above. In contrast thereto, according to the invention, the relative movement of the collet in relation to the collet receptacle along the longitudinal axis is, however, preferably only a straight-line or an essentially straight-line movement, but not a screwing movement. An essentially straight-line movement is understood to be a movement which combines a straight-line movement with a slightly different movement, in particular, a rotational movement.

The fastening and coupling apparatus also can have a clamping device, which includes the collet and the collet receptacle. The clamping device is configured to maintain the clamping position of the collet in a state unloaded from the outside, to move the collet from the clamping position into the releasing position upon an application of a releasing force to the clamping device from the outside, and to move the collet from the releasing position into the clamping position upon the elimination of the releasing force. The clamping device may also include the coupling shaft in addition to the collet and the collet receptacle, so that the clamping device may be connected directly to the drive unit of the power tool.

Due to the fact that the clamping device is configured to maintain the clamping position of the collet in a state unloaded from the outside, the clamping device may be operated as an “autonomous unit” without a continuous contact with other components outside the clamping device being necessary to maintain the clamping position. Since the clamping position must be maintained, in particular, during the operation of the power tool and thus while the coupling shaft is rotating, in particular, a constant contact of this type between a component of the clamping device rotating with the coupling shaft and a component outside the clamping device not rotating with the coupling device, via which a considerable force would have to be transmitted to maintain the clamping position, would be unfavorable and would result in heating and power losses, due to friction.

The fastening and coupling apparatus also can include a releasing device, in relation to which the coupling shaft is rotatable, i.e., the releasing device does not rotate together with the rotating coupling shaft, but instead is arranged in an essentially unmovable manner relative to the power tool, but it may itself also include moving parts. The releasing device is configured to apply the releasing force to the clamping device during an actuation of the releasing device when the coupling shaft is stationary.

Since, for safety reasons, the tool shank may in any case be released from the collet only when the coupling shaft is stationary, it is not disadvantageous that a contact with a component outside the clamping device, namely the releasing device, is necessary to generate the releasing force.

Finally, the fastening and coupling apparatus can include an actuating device, which may be actuated by the user of the power tool, in particular by manual power, and is configured to actuate the releasing device as well as to end the actuation of the releasing device. By actuating the actuating device, the user may thus place the collet in the releasing position with the aid of the releasing device for the purpose of carrying out a tool change and/or a change of the collet, and to place the collet into the clamping position for the purpose of fastening the rotating tool and thus using the power tool.

The fastening and release of the tool to or from the power tool therefore easily takes place only by actuating the actuating device, in particular, by manual power. Since the actuating device is a subunit of the fastening and coupling apparatus and thus a part of the power tool, a separate tool is not necessary for this purpose. The object underlying the invention is thus achieved thereby.

The clamping device can have at least one pretensioned spring element to maintain the clamping position of the collet in the state unloaded from the outside. This represents a simple structural way to generate the force for maintaining the clamping position without requiring a continuous contact to further components outside the clamping device.

The entire clamping device can rotate together with the coupling shaft and thus does not cause any bearing load during the operation of the power tool. However, it is also conceivable that the pretensioned spring element does not also rotate and, is supported, for example, on a housing of the fastening and coupling apparatus on one side and on an axial bearing on the other side, the spring force for maintaining the clamping position of the collet then being transferred via the axial bearing.

The clamping device can be configured to pull the collet into the collet receptacle by means of a restoring force generated by a pretensioning of the at least one pretensioned spring element. This inward pulling then represents the necessary relative movement of the collet along the longitudinal axis in relation to the collet receptacle. The movement preferably takes place in the direction of the inner end of the collet, by which means tongues arranged on the collet are pressed radially to the inside and clamp the tool shank in place in the manner described above, due to the wedge action of two conical faces, arranged one inside the other, of the collet and the collet receptacle. In this way, the same collet and the same collet receptacle as those in the prior art may essentially be used, which reduces the outlay for the technical implementation of the invention.

The clamping device can have a tensile rod for transferring the tensile force from the at least one pretensioned spring element to the collet, and the collet is detachably connected to the tensile rod, in particular, by a screw connection or a bayonet connection. This may again effectuate the fact that the same collet as that in the prior art may be used, in particular if the known collet—as described above—may be screwed into the collet receptacle and is screwed by means of the tensile rod instead of the thread provided for this purpose. In the case of a screw connection between the collet and the tensile rode, the tensile force acting upon the collet may also be steplessly set via the screw thread. When using a different connecting technique, for example a bayonet connection, the necessary modifications to the known collet are also extremely slight. This variant furthermore has the advantage that the collet may be replaced separately, for example, if it is damaged or if a rotating tool having a different shank diameter is to be clamped.

The at least one pretensioned spring element can be at least one disk spring, preferably a stack made up of a plurality of disk springs. Since an individual disk spring may generate a very high spring force, a high spring force may also still be achieved, in particular, by a stack made up of a plurality of disk springs with a spring displacement multiplied by the number of disk springs. A high spring force of this type is also necessary to achieve a sufficiently strong and thus secure clamping of the tool shank in the collet.

The releasing device can be configured to apply the releasing force to the clamping device while the coupling shaft is stationary in such a way that it counteracts the restoring force generated by the pretensioning of the at least one pretensioned spring element. This again provides a simple structural way to generate the releasing force.

The clamping device also can have a release prevention device, which is configured to prevent the releasing force from being applied to the clamping device while the coupling shaft is rotating. As mentioned above, the tool shank may be released from the collet only while the coupling shaft is stationary for safety reasons. A release of the tool shank from the collet while the coupling shaft is rotating could result in the rotating tool separating from the power tool in an uncontrolled manner while it has a significant kinetic energy, due to its rotation. This could result in damage to the workpiece currently being processed, to the rotating tool itself, or to the power tool, or, in the worst case, result in injuries to the user of the power tool and must therefore absolutely be prevented. The release prevention device thus ensures that this safety requirement is met.

The release prevention device can be arranged so that it is rotatably fixed in relation to the coupling shaft and have at least one centrifugal weight. The releasing device is arranged in such a way that the application of the releasing force to the clamping device takes place during an actuation of the releasing device while the coupling shaft is stationary, due to a contact and a transfer of the releasing force in the direction of the longitudinal axis between at least one first contact point on the at least one centrifugal weight and at least one second contact point on the releasing device. The at least one centrifugal weight is pretensioned radially to the inside, and, while the coupling shaft is rotating, the at least one first contact point is movable radially to the outside by the centrifugal force in such a way that, during an actuation of the releasing device while the coupling shaft is rotating, no contact may take place between the at least one first contact point and the at least one second contact point, and thus also no transfer of the releasing force. The prevention of the transfer of the releasing force from the releasing device to the clamping device while the coupling shaft is rotating is thus controlled exclusively via the centrifugal force, which automatically occurs while the coupling shaft is rotating. This technical implementation of the release prevention device has the advantage that it manages without an, in particular, electrical or electronic controller having sensors and/or actuators, but instead uses only mechanical components and is therefore reliable and maintenance-free.

The at least one centrifugal weight can have at least one projection and/or at least one indentation in the region of the at least one first contact point, and the releasing device has at least one protection and/or at least one indentation in the region of the at least one second contact plane, in each case in relation to a plane situated perpendicularly to the longitudinal axis, these being arranged in such a way that the at least one centrifugal weight is movable radially to the outside in the case of a contact and a transfer of the releasing force between the at least one first contact point and the at least one second contact point and during a startup of the coupling shaft from the standstill, by which means no further contact may take place between the at least one first contact point and the at least one second contact point, and thus also no transfer of a releasing force. In this way, it is ensured that, when the releasing device is actuated, the actuation of the releasing device is stopped upon the startup of the coupling shaft. This ensures that, upon the startup of the coupling shaft, a secure fastening of the tool is established when the collet is in the releasing position. This must also be ensured for safety reasons, since it could otherwise be possible in this situation as well that the rotating tool is separated from the power tool in an uncontrolled manner while the coupling shaft is rotating.

The actuating device can be configured to convert a rotational movement of an actuating element, coaxial to the longitudinal axis and carried out by the user, into a movement along the longitudinal axis for actuating the releasing device. In particular, a rotational movement around a very large angle may be implemented with the aid of a rotary grip as the actuating element without the rotary grip needing to have large dimensions or requiring a large installation space on the power tool, since the rotary grip may be easily arranged around the fastening and coupling apparatus and, in particular, coaxially to the longitudinal axis. A rotational movement around a large angle also makes it possible to reduce the torque needed to actuate the rotary grip, which must be applied by the user, in particular by manual power. A rotational movement of this type for actuating the actuating device thus increases the operating comfort when changing tools.

The conversion of the rotational movement into the movement along the longitudinal axis can take place with the aid of a wedge gear. This represents a simple structural way to achieve the conversion of the movement. In particular, a force transmission may be achieved with the aid of a wedge gear, so that a rotational movement of the actuating element over a large angle may be converted by means of a low torque into a movement along the longitudinal axis over a shorter distance, however using a correspondingly higher force.

The wedge gear can have at least one linkage groove with at least one section running at an angle with respect to a plane situated perpendicularly on the longitudinal axis and at least one linkage follower, which is displaceable in the linkage groove. The linkage groove is arranged such that it is unmovable relative to the power tool, and the linkage follower is arranged such that it is rotatable around the longitudinal axis, or vice-versa. The wedge gear in this case is implemented by the angled section of the linkage groove in connection with the linkage follower, which is also pushed in the direction of the longitudinal axis during a movement in the linkage groove. The force transmission of the wedge gear may be easily set by selecting the inclination of the angled section of the linkage groove.

The wedge gear can have two faces opposite each other in the longitudinal direction, at least one of which has a section running at an angle with respect to a plane situated perpendicularly on the longitudinal axis. Exactly one of the two faces is arranged to be rotatable around the longitudinal axis, and exactly one of the two faces is arranged such that it is displaceable along the longitudinal axis, and at least one rolling element, in particular at least one ball, is arranged between the two faces. The face which is rotatable around the longitudinal axis and the face which is displaceable along the longitudinal axis may be the same face or also different faces. In one structural example, the two faces are preferably the axial end faces of two rings, which are arranged coaxially to the longitudinal axis, the ring being rigidly connected to the actuating element with the aid of the face rotatable around the longitudinal axis, and the ring being connected to the releasing device with the aid of the face displaceable along the longitudinal axis for the purpose of actuating them.

The wedge gear in this case can be implemented by the angled section of at least one of the two faces in connection with the at least one rolling element, by which means the axial distance between the two faces changes during the rolling of the at least one rolling element on the angled section of the one face. Due to the rotation of the rotatable one of the two faces, the one of the two faces displaceable along the longitudinal axis is then moved in a correspondingly axial manner by means of the wedge gear. The force transmission of the wedge gear may be easily set by selecting the inclination of the inclined section of at least one of the two faces.

Compared to the variant described earlier with the linkage groove and the linkage follower, this variant has the advantage that the components on which the two faces are arranged, i.e., in particular, the two rings, may be manufactured separately and thus from a hard material, in particular from steel. The material of the component into which the linkage groove is introduced, on the other hand, may be predefined on the basis of the construction of the fastening and coupling apparatus. For example, this component must be made from aluminum for reasons of weight. However, aluminum is significantly softer than steel, so that the movement of the linkage follower, which is, however, to be manufactured from steel for reasons of strength, may press into, expand, or damage the linkage groove. However, if the two components forming the wedge gear—such as the two faces and the at least one rolling element in the present variant—are made from steel, this danger does not exist.

The invention furthermore relates to a power tool comprising a drive unit and a fastening and coupling apparatus according to the invention connected to the drive unit.

The power tool according to the invention can have a sensor, in particular a position sensor, which is configured to detect an actuation of the releasing device, as well as a drive controller, which is configured to control the drive unit in such a way that a startup of the coupling shaft from a standstill is prevented when the releasing device is actuated. The sensor detects, in particular, an axial position of a component of the releasing device, which applies the releasing force to the clamping device, and an actuation of the releasing device on this basis. This represents an alternative approach to the problem that a startup of the coupling shaft from a standstill must be prevented for safety reasons when the releasing device is actuated. While the approach described farther above took place purely mechanically by means of at least one projection and/or at least one indentation in each case on the at least one centrifugal weight and on the releasing device, the present approach uses a preferably electrical or electronic drive controller in the power tool. This is more cost-effective compared to the mechanical approach, in particular if a drive control which is already present has only to be additionally equipped with the function according to the present example.

The drive unit can have an electric motor, a current sensor for detecting the motor current, and a drive controller, which is configured to detect an actuation of the releasing device based on the detection of the motor current during the startup of the coupling shaft from a standstill, and to control the drive unit in such a way that a startup of the coupling shaft from a standstill is prevented when the releasing device is actuated. This represents a further alternative approach to the problem that a startup of the coupling shaft from a standstill must be prevented for safety reasons when the releasing device is actuated. This approach makes use of the fact that, when a releasing device is actuated, a high friction between the releasing device and the clamping device, and thus a great mechanical resistance acting upon the coupling shaft, which must be overcome by a greater electrical power of the electric motor, is generated by the releasing force upon the startup of the coupling shaft. This, in turn, allows the motor current to increase, which may be detected by the current sensor. The advantages of this variant result similarly to the variant described above, the additional advantage arising that the current sensor may be integrated directly into the drive controller, and an additional installation space and cabling between the drive controller, which is generally housed in the drive unit, and a sensor in the fastening and coupling apparatus, are unnecessary.

Further scope of applicability of the present invention will become apparent from the detailed description given hereinafter. However, it should be understood that the detailed description and specific examples, while indicating preferred embodiments of the invention, are given by way of illustration only, since various changes, combinations and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a power tool according to an example of the invention from above;

FIG. 2 shows an example of a fastening and coupling apparatus according to the invention in a perspective exploded representation;

FIG. 3 shows the example in a side view, the rotary grip and the neck journal bearing having been removed;

FIG. 4 shows a sectional representation of the example with a stationary coupling shaft;

FIG. 5 shows a sectional representation of the first example with a rotating coupling shaft;

FIG. 6 shows the release prevention device of the example with a stationary coupling shaft;

FIG. 7 shows the release prevention device of the example with a rotating coupling shaft;

FIG. 8 shows an alternative design of the release prevention device of the first example with a stationary coupling shaft;

FIG. 9 shows a gradient ring of the actuating device of the example;

FIG. 10 shows the actuating device of the first example; and

FIG. 11 shows an example of a fastening and coupling apparatus according to the invention in a perspective exploded representation.

### DETAILED DESCRIPTION

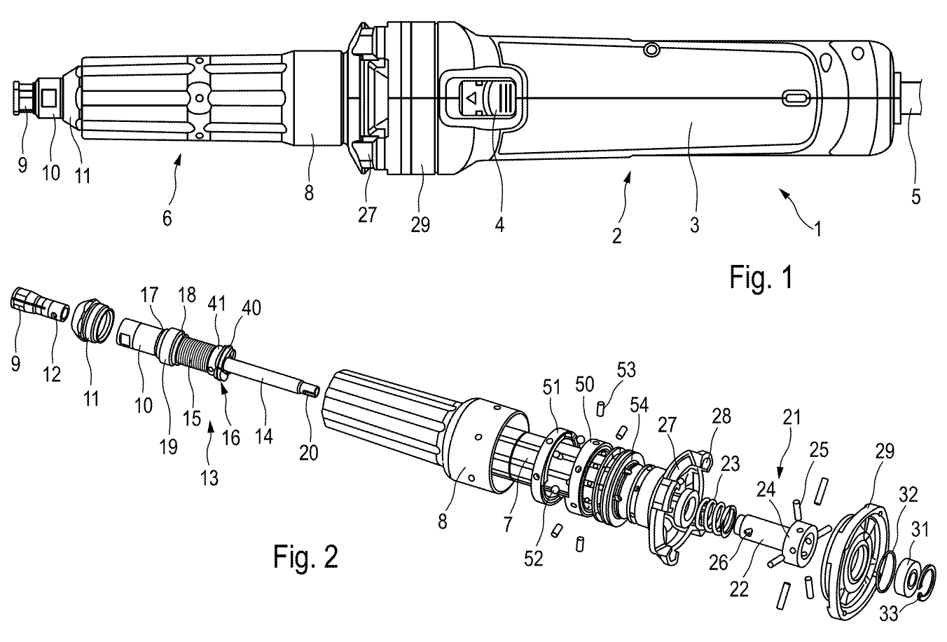

FIG. 1 shows a power tool 1 according to the invention, in this case based on the example of a straight grinder. FIGS. 2 through 10 show a first example of a fastening and coupling apparatus 6 according to the invention and are therefore described together in the following.

Power tool 1 has a drive unit 2, including an electric motor, and fastening and coupling apparatus 6 as main components. Since power tool 1 is a straight grinder, all components of the drive train are arranged along a longitudinal axis of power tool 1.

Drive unit 2 has a housing 3 and a switch 4 for switching the electric motor on and off, as well as a cable 5 for the mains connection of power tool 1. The further components of drive unit 2, such as a gearset, a fan, or a power supply unit are not relevant to the present invention and are therefore not described.

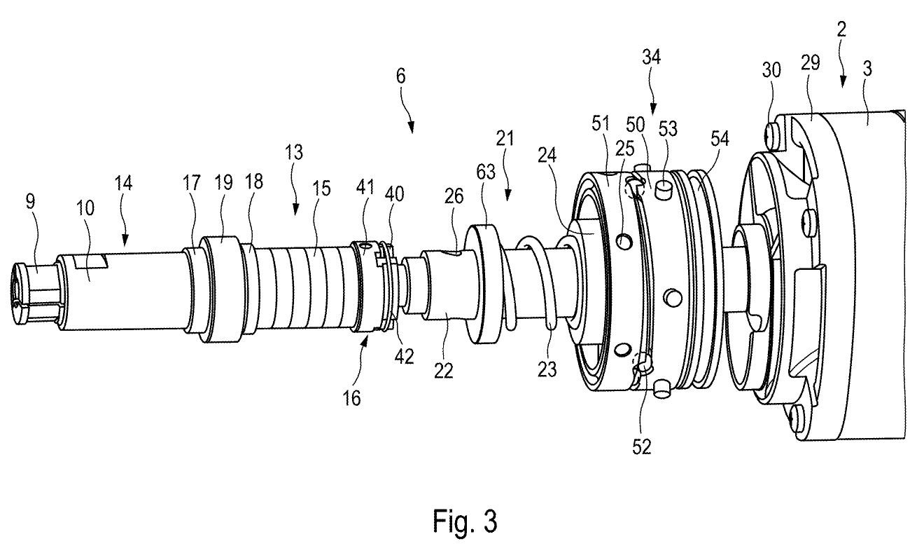

Fastening and coupling apparatus 6 is flanged onto the end face of drive unit 2 and forms the neck of power tool 1. The housing of fastening and coupling apparatus 6 is formed by a continuous neck journal bearing 7, which has a flange 27, which is screwed onto an end-face cover 29 of drive unit 2 with the aid of screws 30 and corresponding screw openings 28 (cf. FIGS. 2 and 3).

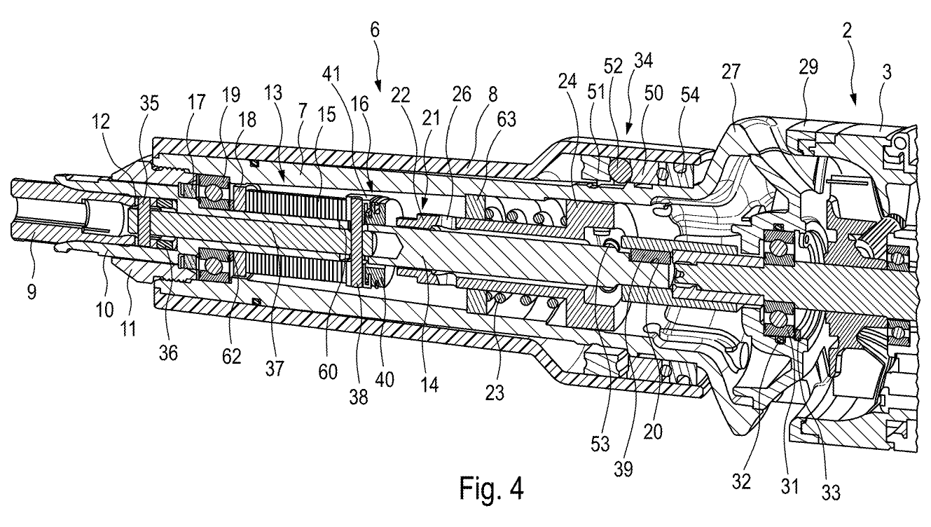

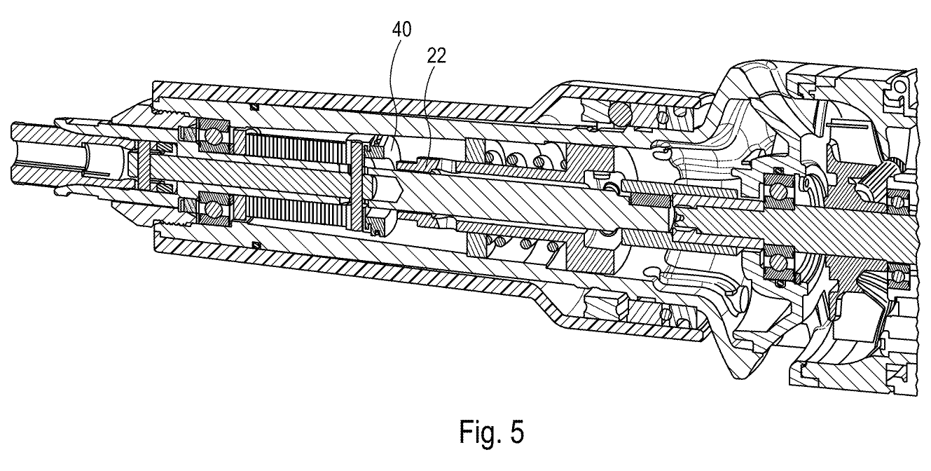

Neck journal bearing 7 also has a conical section of a smaller diameter, which is surrounded by a rotary grip 8, which is also slightly conical in an outer section and cylindrical in an inner section. On the outer end of rotary grip 8, a collet 9 and a collet receptacle 10 project beyond neck journal bearing 7 and rotary grip 8. Along with a coupling shaft 14 and further components, these are part of a clamping device 13 (cf. FIGS. 2 through 5), which is arranged in the interior of neck journal bearing 7 and is described in detail below. Clamping device 13—with the exception of the aforementioned projecting parts—is protected against dust and foreign bodies, by a protective sleeve 11, which is screwed into a thread on the outer end of neck journal bearing 7 and closes this end (cf. FIGS. 4 and 5).

Collet 9 is used to receive a tool shank, which is cylindrical in the example. On its outer end, collet 9 is slitted multiple times in parallel to the longitudinal axis of power tool 1, by which means multiple tongues are formed. Collet 9 has a section with a conical outer face, which is inserted into a corresponding section of collet receptacle 10 having a conical inner face. If collet 9 is moved axially in the direction of collet receptacle 10, the two conical faces are thus pushed into each other. The tongues of collet 9 are pressed radially to the inside thereby, and the tool shank inserted into collet 9 is thus clamped in place. Collet 9 has the same functionality as a collet from the prior art. In this respect, reference is hereby made to the above description of a known collet of this type.

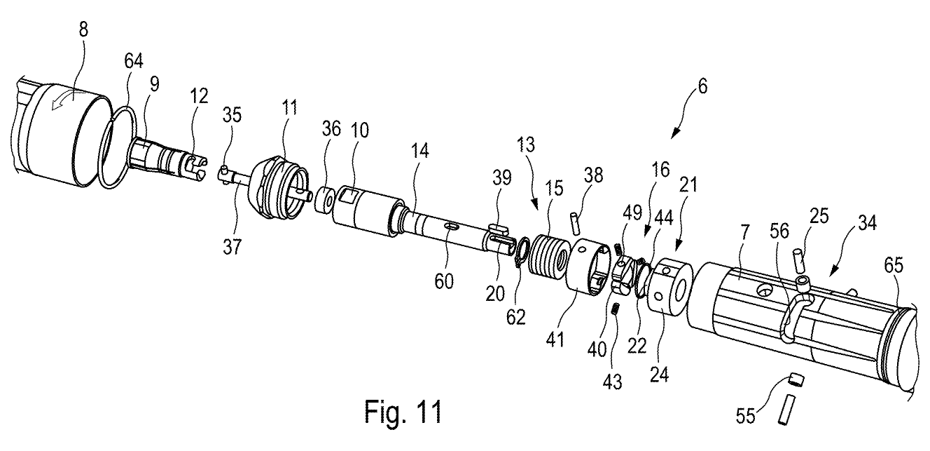

On its inner end, collet 9 is provided with a bayonet fitting 12, with the aid of which it may be mounted by a combined plug and rotational movement in a pin 35, which is inserted through a radial bore on the end of a tensile rod 37 and protrudes over the bore on both sides (cf. FIGS. 4 or 11 (identical to the second example)). Collet 9 is coaxially and rotatably fixedly connected to tensile rod 37 by bayonet fitting 12.

Bayonet fitting 12 is designed in such a way that a slight peak must be overcome to mount and remove collet 9 in and out of pin 35. In this way, an unintentional release of collet 9 from collet receptacle 10 is prevented when collet 9 is clamped and is thus itself under a tensile stress, in particular during the operation of power tool 1.

So that collet 9 is nevertheless unable to rotate and fall out of collet receptacle 10 in the released state, when it is not under a tensile stress, it is pretensioned slightly to the outside by a spring element, an elastomer element 36 in the example. Elastomer element 36 is arranged in the inner, closed end of collet receptacle 10. Its restoring force presses collet 9 away from collet receptacle 10 and thereby away from pin 35 and thus holds the bayonet connection in the closed state. The restoring force of elastomer element 36 may, however, be easily overcome manually by the user of power tool 1 in order to replace the collet without a tool, for example, if a collet having a different inner diameter is needed.

Collet 9, collet receptacle 10, coupling shaft 14, as well as tensile rod 37 are part of a clamping device 13 (cf. FIGS. 2 through 5). Collet receptacle 10 is connected to coupling shaft 14 and forms the outer end thereof. The connection between collet receptacle 10 and coupling shaft 14 may takes place as a single piece, seamlessly, or in a materially bonded manner. Coupling shaft 14 is also designed as a hollow shaft in its outer part for the purpose of receiving tensile rod 37 in its interior in an axially displaceable manner.

Coupling shaft 14 is connected on its inner end to an output shaft of an electric motor in drive unit 2 in a torque-transmitting manner via a wedge joint, using a longitudinal groove 20 (cf. FIG. 2) and a wedge 39 (cf. FIG. 11 for the identical wedge joint in the second example). The output shaft of the electric motor is supported in drive unit 2 by a roller bearing 31, which is sealed by a sealing ring 32 and is secured by a securing ring 33.

Clamping device 13 causes collet 9 to remain clamped from the outside even without the application of force to clamp a tool shank in place. For this purpose, clamping device 13 also has a disk spring package 15 with disk springs (twenty-four in the example), which are arranged as a stack coaxially around coupling shaft 14. On its outer end, disk spring package 15 is supported via a balance ring 18 on a securing ring 62, which is inserted into a groove on coupling shaft 14. The balance ring is furthermore adjusted in such a way that possible imbalances on coupling shaft 14 are largely compensated for, which are caused, in particular, by the other components of clamping device 13. On its inner end, disk spring package 15 is supported on the outer end face of a centrifugal weight carrier 41 of a release prevention device 16, which is described in greater detail father below. Centrifugal weight carrier 41 is also arranged with an inner bore coaxially on coupling shaft 14. A pin 38, which is guided in the inner bore of centrifugal weight carrier 41 through elongated holes 60 in coupling shaft 14, is inserted through radial, opposing openings 46 in centrifugal weight carrier 41, by which means centrifugal weight carrier 41 is rotatably fixedly, yet axially displaceably, connected to coupling shaft 14. Pin 38 is also inserted radially entirely on the inside through a radial bore in tensile rod 37 and in this way forms a rigid connection between centrifugal weight carrier 41 and tensile rod 37. Tensile rod 37 is thus drawn to the inside by the restoring force counteracting the pretensioning of disk spring package 15, whereby the clamping position of collet 9 is maintained.

Clamping device 13 thus operates as an “autonomous unit” as a result of the pretensioning of disk spring package 15, which is intended to mean that it maintains the clamping position of collet 9 without an application of force from the outside, in particular when it rotates together with coupling shaft 14.

Clamping device 13 is supported radially to the outside against the inside of neck journal bearing 7 by means of a roller bearing 19. Roller bearing 19 is arranged on coupling shaft 14 between a radial shoulder on the inner end of collet receptacle 10 and securing ring 62 already described. Outside roller bearing 19, a felt ring 17 is also arranged on coupling shaft 14, which is used as a dust protection against the penetration of, for example, abrasive dust, which could contaminate and damage roller bearing 19 and the other components in the interior of neck journal bearing 7, from the outside through protective sleeve 11.

For the purpose of tool changes, a possibility must be provided on power tool 1 to move clamping device 13 from its clamping position into its releasing position in order to open collet 9 and to permit the removal or insertion of a tool shank. A releasing device 21 and an actuating device 34, by means of which the operator of power tool 1 may actuate releasing device 21, are used for this purpose. They are both described in detail below.

Actuating device 34 has rotary grip 8 as the actuating element for the user of power tool 1, which, due to its length, may be gripped and rotated by the user entirely with one hand while holding power tool 1 by drive unit 2 with the other hand. In the example, when changing tools, the user turns rotary grip 8 counter-clockwise, viewed in the direction of the outer end, for the purpose of actuating releasing device 21, and turns it clockwise to end the actuation of releasing device 21. However, rotations in each of the opposite directions may, of course, also be provided.

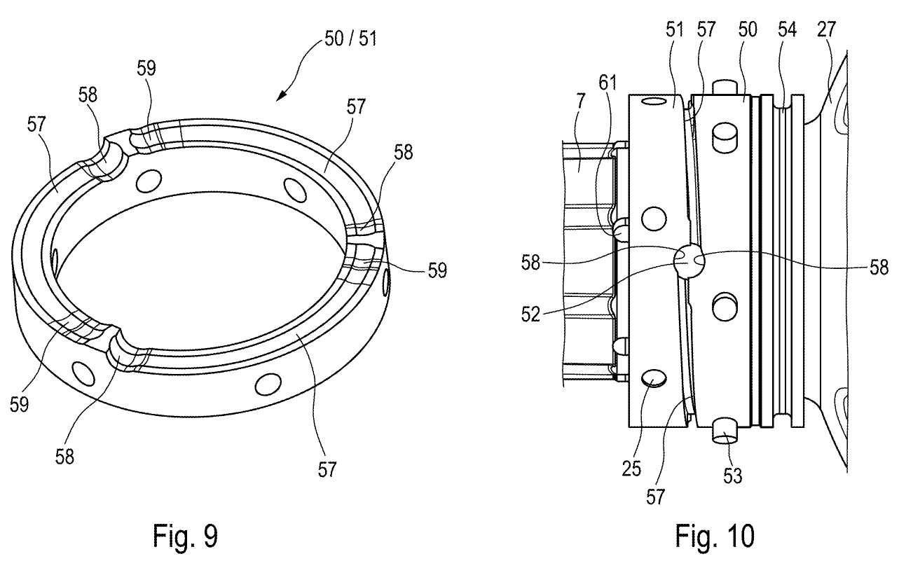

Rotary grip 8 has a section of a larger diameter on its inner end. A first gradient ring 50 and a second gradient ring 51 are arranged radially between this section and neck journal bearing 7, coaxially to the longitudinal axis of power tool 1, as essential components of actuating device 34, and also an axial bearing 54. Axial bearing 54 supports the reaction forces generated by actuating device 34 and acting to the inside, i.e., in the direction of drive unit 2, against neck journal bearing 7. The components of actuating device 34 are illustrated in detail, in particular, in FIGS. 9 and 10.

First gradient ring 50 is rigidly connected to rotary grip 8 by pins 53 pointing radially to the outside and is thus arranged such that it is rotatable with respect to neck journal bearing 7 but is not axially displaceable. Alternatively, screws may also be employed instead of pins 53. Second gradient ring 51 has pins 25 pointing radially to the inside, which are guided through elongated holes 61 in neck journal bearing 7 within second gradient ring 51, and is thus arranged such that it is not rotatably with respect to neck journal bearing 7 but is axially displaceable.

In the example, first and second gradient rings 50, 51 are manufactured to be of the same design, which lowers the development and manufacturing costs of fastening and coupling apparatus 6. Gradient rings 50, 51 each have a plurality of ball tracks 57 of the same length (three in each case in the example) on their opposing end faces. A ball 52, which is arranged between the two gradient rings 50, 51, may roll simultaneously on each of two opposing ball tracks 57 on first and on second gradient ring 50, 51. In each case, a first latching notch 58 in the form of an indentation in ball track 57 is arranged at one end of each ball track 57, and a second latching notch 59, also in the form of an indentation in ball track 57, is arranged in each case at the other end of each ball track 57, first latching notch 58 being deeper in each case that second latching notch 59. Due to the fact that ball tracks 57 are of equal length and are thus distributed evenly over the circumference of the end faces of the two gradient rings 50, 51, either all balls 52 are situated simultaneously in first latching notches 58, or all balls 52 are situated simultaneously in second latching notches 59, or all balls 52 are situated simultaneously at points on ball tracks 57 corresponding to each other. Due to the stable location of balls 52 in first or second latching notches 58, 59, a first or second latching position of actuating device 34 results there. The two latching positions correspond to the two ends of the rotational movement of grip 8, the first latching position corresponding to the idle position, i.e., the unactuated position, and the second latching position corresponding to the fully actuated position of actuating device 34. As is apparent in FIG. 9, the transitions between a first latching notch 58 of a ball track 57 and a second latching notch 59 of an adjacent ball track 57 is formed in each case by raised regions situated therebetween as well as by sharp inclinations in such a way that a crossing over of balls 52 is not possible in this direction.

Ball tracks 57 are inclined with respect to a plane situated perpendicularly to the longitudinal axis of power tool 1, for example, by 2.3 degrees, and have a constant inclination in this example. Opposing ball tracks 57 therefore run in parallel to each other on first or on second gradient ring 50, 51. If first gradient ring 50 is now rotated counter-clockwise via rotary grip 8 and pins 53, each ball 52 is initially pressed simultaneously out of the two first latching notches 58 on both gradient rings 50, 51, by which means the first latching position is overcome, and the fact that the idle position is being left is signaled to the user by haptic feedback. Each ball 52 then rolls along one ball track 57 on first and second gradient rings 50, 51, however, only first gradient ring 50 rotating. As is apparent on the basis of FIG. 10, each ball 52 moves clockwise relative to first gradient ring 50 and counter-clockwise relative to gradient ring 51, the axial extension of the two gradient rings 50, 51 always increasing at the two contact points with ball 52, due to the angled arrangement of the two ball tracks 57. Since first gradient ring 50 is not axially displaceable, since it is supported by axial bearing 54, second gradient ring 51 instead moves to the outside. At the end of the rotational movement of rotary grip 8 (by approximately 210 degrees in the example), each ball 52 on the two gradient rings 50, 51 engages with particular second latching notch 59, whereby the fact that the second latching position was reached and actuating device 34 was thus filly actuated is signaled to the user.

In an example, rotary grip 8 may be designed in such a way that the end of the predefined rotational movement is already reached after 120 degrees, and balls 52 engage with corresponding second latching notches 59.

In an example, the inclination of ball tracks 57 may be provided with a variable design. This makes it possible to adapt or to reduce the actuating forces.

During the axial movement of second gradient ring 51, pins 25 in elongated holes 61 in neck journal bearing 7, and thus also ring 24 of releasing device 21 and a pressure piece 22 rigidly connected thereto, are pushed to the outside. The outer end face of pressure piece 22 then presses against the inner end face of centrifugal weights 40 of release prevention device 16, as is apparent in FIG. 4. The latter pushes tensile rod 37 to the outside against the restoring force generated by pretensioned disk spring package 15, as described above, and thus releases collet 9, so that a tool change may be carried out.

On its cylindrical part, close to its outer end, pressure piece 22 has a continuous, triangular opening 26, which is used, however, only for a simplified mounting and centering of pressure piece 22.

During the movement of actuating device 34 from the first latching position into the second latching position, a spiral spring 23 is simultaneously tensioned. Spiral spring 23 is supported by its outer end on a ring 63 pressed firmly into neck journal bearing 7 and by its inner end on ring 24 of releasing device 21 (cf. FIG. 4).

The opposite movement of actuating device 34 from the second latching position into the first latching position runs similarly to the movement described above but in the opposite direction, and it causes second gradient ring 51 to move again to the inside. As a result, the pressure by pressure piece 22 onto centrifugal weights 40 is lifted again, and collet 9 is again clamped with the aid of clamping device 13, by which means the tool change is completed.

Since spiral spring 23 is also relaxed during this opposite movement, and second gradient ring 51 is pressed to the inside, the user has only to overcome the second latching position in the opposite direction and release rotary grip 8, after which the aforementioned opposite movement, driven by the relaxing of spiral spring 23, takes place automatically. At the end of this automatic opposite movement of actuating device 34, balls 52 finally also engage automatically with first latching notches 58, by which means actuating device 34 is again in the idle position, and this is signaled to the user by the “snap-in” of rotary grip 8. The operating comfort of power tool 1 is further improved hereby.

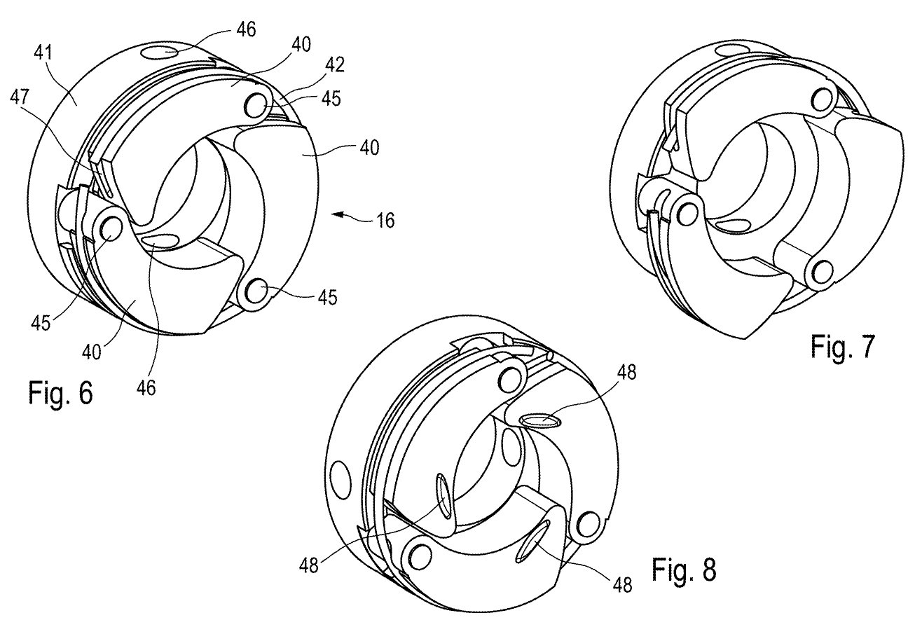

As explained above, collet 9 should be released only while coupling shaft 14 is at a standstill for safety reasons. To prevent collet 9 from being released while coupling shaft 14 is rotating, release prevention device 16 is provided, which is illustrated in detail in FIGS. 6 and 8.

Release prevention device 16 has multiple centrifugal weights 40 (three in the example), which are arranged on the inner end face of a centrifugal weight carrier 41 such that they are each able to rotate around an axis running in parallel to coupling shaft 14, due to pivot bearings 45. Centrifugal weight carrier 41 has two openings 46 situated radially opposite each other, through which a pin 38 is guided, as described above, and is connected radially on the inside to tensile rod 37.

Centrifugal weights 40 are pretensioned radially to the inside by a shared circumferential lock washer 42, which is guided in grooves 47 of centrifugal weights 40 (cf. FIGS. 4, 6, and 8). When coupling shaft 14 rotates, centrifugal weights 40 are moved radially to the outside around each pivot bearing 45 by the centrifugal force which is then active (cf. FIGS. 5 and 7). When coupling shaft 14 comes to a standstill again, centrifugal weights 40 are again pressed radially to the inside by lock washer 42.

The outer end face of pressure piece 22 is arranged in such a way that it contacts the inner end face of centrifugal weights 40 in a radially inner region when centrifugal weights 40 are in their idle position, i.e., are not being moved to the outside by the centrifugal force. In this position of centrifugal weights 40, the releasing force may be transferred from pressure piece 22 to centrifugal weights 40 and via centrifugal weight carrier 41 and tensile rod 37 to release collet 9. The radius of the contact face between pressure piece 22 and centrifugal weights 40 is, however, so small that, when centrifugal weights 40 are moved to the outside by the centrifugal force, a contact between pressure piece 22 and centrifugal weights 40 may no longer take place. If actuating device 34 is actuated while coupling shaft 14 is rotating, the outer end face of pressure piece 22 therefore presses “into space.” This prevents collet 9 from being released during the rotation of coupling shaft 14.

FIG. 8 shows another variant of release prevention device 16, in which each centrifugal weight 40 has a projection 48 in the contact region with pressure piece 22, i.e., on the radially inner edge of its end face, which is preferably provided with a lens-shaped design in cross-section. In this variant, the outer end face of pressure piece 22 correspondingly has spiral-shaped grooves. They engage with projections 48 in the circumferential direction during a relative rotational movement between centrifugal weights 40 and pressure piece 22 and cause centrifugal weights 40 to then also be moved to the outside, so that a contact no longer takes place between pressure piece 22 and centrifugal weights 40.

When power tool 1 is switched on while releasing device 21 is being actuated and coupling shaft 14 begins to rotate, this causes pressure piece 22 to again be pressed “into space,” the releasing force acting upon clamping device 13 to be released, and collet 9 to again clamp tool shank in place. The state is then avoided that collet 9 is not clamped during the startup of coupling shaft 14 while releasing device 21 is being actuated.

In this case, release prevention device 16 may not perform its above-described function, since the friction generated by the pressure of pressure piece 22 upon centrifugal weights 40 would prevent centrifugal weights 40 from moving radially to the outside, and the low rotational speeds would furthermore also not generate a sufficiently high centrifugal force upon the startup of coupling shaft 14.

As described above, as an alternative to this variant, however, the startup of coupling shaft 14 while releasing device 21 is being actuated may also be prevented entirely, in particular, with the aid of a position sensor or a monitoring of the motor current of an electric motor in drive unit 2.

FIG. 11 shows a second example of a fastening and coupling apparatus 6 according to the invention. This differs from the first example according to FIGS. 2 through 10 essentially by a different construction of actuating device 34.

In this second example, the rotational movement of grip 8 is not converted into an axial movement by two gradient rings but instead by a linkage controller. For this purpose, neck journal bearing 7 has multiple linkage grooves 56 (again, three in the example), which are designed as elongated holes. A radially arranged pin (alternatively, a screw) 25 is displaceable arranged in each linkage groove 56 as a linkage follower. A roll 55 is also arranged in each case around pin 25, which rolls in linkage groove 56 to reduce the friction between the linkage follower and linkage groove 56. Pins 25 are fixedly connected to rotary grip 8 on their radially outer ends and are also fixedly connected to ring 24 of releasing device 21 in corresponding openings thereof at their radially inner ends.

Each linkage groove 56 has a sharply bent section on at least one end in each case, by means of which a first latching position is implemented, in a similar manner as described above in connection to the first example. it is adjoined by a longer section, which is inclined in relation to a plane situated perpendicularly to the longitudinal axis of power tool 1. When pin 25 moves with roll 55 along this angled section of linkage groove 56, the unit made up of rotary grip 8 and ring 24 simultaneously moves to the outside, due to the wedge action of the linkage controller. The inclination of the angled section of linkage groove 56 may be variable, so that the user may more easily overcome the increasing spring force of clamping device 13, which counteracts the rotational movement of grip 8. A section for implementing a second latching position is arranged at the other end of linkage groove 56. This second latching position is implemented in that the inclination of linkage groove 56 in this region changes to the other direction, for example, becomes negative.

Linkage groove 56 may also have a section which runs essentially in parallel to the longitudinal axis, so that a sliding movement and a rotational movement (or vice versa) are necessary one after the other to actuate actuating device 34. This is used for increased security during the operation of power tool 1, since two separate movement processes are necessary to release the tool.

In contrast to the first example, in this case, therefore, rotary grip 8 also moves to the outside, which, however, does not have a bothersome effect, due to the limited axial travel distance during the actuation of actuating device 34. Conversely, this also provides the advantage that the first latching position may be implemented by an engagement of rotary grip 8 with an axial position. For this purpose, a retaining ring 64 made from round wire is provided, which is inserted into a groove in the radially inner surface of grip 8 and, in the first latching position, may simultaneously engage with a groove 65 on the radially outer surface of neck journal bearing 7. Correspondingly, a second groove, in parallel thereto, may also be provided on the radially outer surface of neck journal bearing 7 for the second latching position. During the movement of grip 8 between the first and second latching positions, retaining ring 64 is pressed against the latter radially to the outside even deeper into the groove in grip 8, which is designed to be correspondingly deeper for this purpose.

A pressure piece 22 is formed on the outer end of ring 24 of releasing device 21, which presses onto centrifugal weights 40 of release prevention device 16 in the manner described above in connection with the first example when coupling shaft 14 is at a standstill. In contrast to the first example, ring 24, also rotates, and thus also pressure piece 22 during its axial displacement, which, however, does not have a disadvantageous effect on the transmission of force into centrifugal weights 40.

In the example, release prevention device 16 also differs slightly from the one in the first example. Centrifugal weights 40 here are arranged axially entirely within centrifugal weight carrier 41 and are prevented from falling out by a securing ring 44 on the inner side of centrifugal weight carrier 41. In this case, the pretensioning of centrifugal weights 40 radially to the inside also does not take place by a shared circumferential lock washer but instead takes place individually for each centrifugal weight 40 by a small spiral spring 43, which is supported radially on the outside on the lateral surface of centrifugal weight carrier 41 and radially on the inside in a blind bore hole 49 in particular centrifugal weight 40. However, the functionality of release prevention device 16 in the second example is identical to that of the first example.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A fastening and coupling apparatus for a rotating tool, which is provided for connection to a drive unit of a power tool having a rotating drive, the fastening and coupling apparatus comprising:
a coupling shaft with a longitudinal axis, the coupling shaft being rotatable around the longitudinal axis with the aid of the rotating drive when the fastening and coupling apparatus is connected to the drive unit of the power tool;
a collet for detachably receiving an cylindrical tool shank, which is movable between a clamping position, in which the tool shank is clamped in the collet such that it is rotatably fixedly connected to the coupling shaft and is rotatable around the longitudinal axis, and a releasing position, in which the tool shank is removeable from the collet or inserted into the collet due to a relative movement along the longitudinal axis in relation to a collet receptacle rotatably fixedly connected to the coupling shaft as a single piece;
a clamping device that includes the collet and the collet receptacle and is configured to maintain the clamping position of the collet in a state unloaded from the outside, to move the collet from the clamping position into the releasing position upon an application of a releasing force to the clamping device from the outside, and to move the collet from the releasing position into the clamping position upon the elimination of the releasing force;
a releasing device, in relation to which the coupling shaft is rotatable and which is configured to apply the releasing force to the clamping device upon an actuation of the releasing device when the coupling shaft is at a standstill;
an actuating device adapted to be actuated by the user of the power tool by manual power, and is configured to actuate the releasing device and to end the actuation of the releasing device,
wherein the actuating device is configured to convert a rotational movement of an actuating element, coaxial to the longitudinal axis and carried out by the user, into a movement along the longitudinal axis for actuating the releasing device,
wherein the conversion of the rotational movement into the movement along the longitudinal axis takes place via a wedge gear, and
wherein the wedge gear has two faces arranged opposite each other in the longitudinal direction, at least one of which has at least one section running at an angle in relation to a plane situated perpendicularly to the longitudinal axis, exactly one of the two faces being arranged such that it is rotatable around the longitudinal axis, and exactly one of the two faces being arranged such that it is displaceable along the longitudinal axis, and
wherein at least one rolling element or at least one ball is arranged between the two faces.

2. The fastening and coupling apparatus according to claim 1, wherein the clamping device has at least one pretensioned spring element for maintaining the clamping position of the collet in the state unloaded from the outside.

3. The fastening and coupling apparatus according to claim 2, wherein the clamping device is configured to pull the collet into the collet receptacle via a restoring force generated by the pretensioning of the at least one pretensioned spring element.

4. The fastening and coupling apparatus according to claim 3, wherein the clamping device has a tensile rod for transferring the tensile force from the at least one pretensioned spring element to the collet, and the collet is detachably connected to the tensile rod by a screw connection or a bayonet connection.

5. The fastening and coupling apparatus according to claim 2, wherein the at least one pretensioned spring element is at least one disk spring, or a stack made up of a plurality of disk springs.

6. The fastening and coupling apparatus according to claim 2, wherein the releasing device is configured to apply the releasing force to the clamping device while the coupling shaft is at a standstill such that it counteracts the restoring force generated by the pretensioning of the at least one pretensioned spring element.

7. The fastening and coupling apparatus according to claim 1, wherein the clamping device further includes a release prevention device, which is configured to prevent the releasing force from being applied to the clamping device while the coupling shaft is rotating, the release prevention device being rotatably fixedly arranged in relation to the coupling shaft and having at least one centrifugal weight, the releasing device being arranged such that the application of the releasing force to the clamping device during an actuation of the releasing device while the coupling shaft is at a standstill takes place via a contact and a transfer of the releasing force in the direction of the longitudinal axis between at least one first contact point on the at least one centrifugal weight and at least one second contact point on the releasing device, the at least one centrifugal weight being pretensioned radially to the inside, and the at least one first contact point being movable radially to the outside by the centrifugal force while the coupling shaft is rotating, in such a way that, upon an actuation of the releasing device while the coupling shaft is rotating, no contact may take place between the at least one first contact point and the at least one second contact point and thus also no transfer of the releasing force.

8. The fastening and coupling apparatus according to claim 7, wherein the at least one centrifugal weight has at least one projection and/or at least one indentation in the region of the at least one first contact point, and the releasing device has at least one projection and/or at least one indentation in the region of the at least one second contact point, in each case in relation a plane situated perpendicularly to the longitudinal axis, these being arranged in such a way that the at least one centrifugal weight is movable radially to the outside in the case of a contact and a transfer of the releasing force between the at least one first contact point and the at least one second contact point and upon a startup of the coupling shaft from a standstill, via which no further contact takes place between the at least one first contact point and the at least one second contact point, and thus also no transfer of a releasing force.

9. The fastening and coupling apparatus according to claim 1, wherein the wedge gear has at least one linkage groove with at least one section running at an angle in relation to a plane situated perpendicularly to the longitudinal axis and at least one linkage follower, which is displaceable in the linkage groove, the linkage groove being arranged such that it is unmovable relative to the power tool, and wherein the linkage follower is arranged such that it is rotatable around the longitudinal axis, or vice-versa.

10. A power tool comprising:
a drive unit; and
the fastening and coupling apparatus according to claim 1, the fastening and coupling apparats being connected to the drive unit.

11. The power tool according to claim 10, further comprising a sensor or a position sensor, which is configured to detect an actuation of the releasing device, and a drive controller, which is configured to control the drive unit such that a startup of the coupling shaft from a standstill is prevented while the releasing device is being actuated.

12. The power tool according to claim 10, wherein the drive unit has an electric motor, a current sensor for detecting the motor current, and a drive controller, which is configured to detect an actuation of the releasing device based on the detection of the motor current upon the startup of the coupling shaft from a standstill, and to control the drive unit in such a way that a startup of the coupling shaft from a standstill is prevented while the releasing device is being actuated.
